(19) United States
(12) Patent Application Publication
(10) Pub. No.: US 2008/0274408 A1
(43) Pub. Date: Nov. 6, 2008

(54) Anode for Lithium Ion Cell

(76) Inventor: Christine Ruth Jarvis, Oxfordshire (GB)

Correspondence Address: LAW OFFICES OF WILLIAM H. HOLT, 12311 HARBOR DRIVE, WOODBRIDGE, VA, 22192, US

(21) Appl. No.: 11/579,270

(22) PCT Filed: Jun. 7, 2005
(86) PCT No.: PCT/GB2005/50084

§ 371 Date: Nov. 1, 2006

(30) Foreign Application Priority Data
Jun. 24, 2004 (GB) 0414161.0

(51) Int. Cl. H01M 4/58; B05D 5/12

(52) U.S. Cl. 429/231.95; 429/231.8; 427/58

(57) ABSTRACT

An anode for a lithium ion cell comprising stabilised lithium metal powder, polyethylene oxide and a lithium intercalation material. The use of polyethylene oxide as the binder for an anode used in a secondary cell enables lithium powder to be incorporated in the anode leading to an improvement in cell performance.

The present invention relates to an anode for a lithium ion cell comprising stabilised lithium powder and to a process for producing the anode.

For many years it has been known to make cells with lithium metal anodes, and cathodes of a material into which lithium ions can be intercalated or inserted. Such cells may use, as electrolyte, a solution of a lithium salt in an organic liquid such as propylene carbonate, and a separator such as filter paper or polypropylene. For secondary or rechargeable lithium cells, the use of lithium metal anodes is unsatisfactory as problems arise from dendrite growth and electrolyte decomposition on freshly deposited lithium. The elimination of this problem is now possible by employing a material able to intercalate lithium ions reversibly at very low voltages, such as graphite, leading to so-called “lithium-ion”, “rocking-chair”, or “swing” lithium rechargeable batteries. These lithium cells operate on the principle that they contain not lithium metal, but lithium ions which are rocked back and forth between two intercalation materials during the charging and discharging parts of the cycle.

Present lithium-ion cells typically contain a carbon-based anode and a lithiated cathode material, such as LiCoO₂. The lithiated cathode material is the source of lithium for the cell and thus the cell performance is limited by the nature and capacity of the cathode material. To increase the range of materials that can be used in Li-ion cells there have been many attempts to pre-lithiate cells, either chemically before cell assembly, or electrochemically after cell assembly. For example U.S. Pat. No. 5,759,715 (Barker et al) describes the use of a sacrificial lithium electrode to produce a lithiated carbon electrode. Such a process adds considerable cost and complexity to the cell production. Alternatively, pieces of lithium foil have been incorporated into anodes and allowed to react. As these lithium foils tend to be quite thick, they can take significant time to dissolve and achieving a uniform electrode is difficult.

During the formation cycle (first charge) for a conventional lithium ion cell with a carbon composite anode and a lithium metal oxide composite cathode, a solid electrolyte interface (SEI) layer is produced on the surface of the carbon particles, while for a pre-lithiated cell the SEI layer is formed when electrolyte is added to the cell. This layer greatly diminishes any further electrochemical reduction of the electrolyte, and allows the cell to operate for hundreds of cycles. However, producing the SEI layer consumes some of the lithium from the cell. This lithium is no longer available for reaction, and is termed the irreversible capacity of the anode.

U.S. Pat. No. 5,776,369 discloses a stabilised lithium metal powder that has a surface layer which reduces the reactivity of the material and enables it to be used in a dry environment. This material can be added to a composite carbon anode to produce a lithiated electrode. U.S. Pat. No. 6,706,447 describes a battery manufactured to include an anode formed from a host material capable of absorbing and desorbing lithium in an electrochemical system such as a carbonaceous material, and lithium metal dispersed in the host material. However the stabilised lithium metal powder is still reactive with certain solvents such as N-methyl pyrrolidone and dimethyl acetamide that are conventionally used to produce PVdF-based Li-ion electrodes. Styrene butadiene rubbers and other similar binders may also be used in lithium ion cell anodes. These materials are commonly used as an aqueous suspension. When used as an aqueous suspension, these binders are also incompatible with stabilised lithium powder, as the powder reacts with water. Therefore an alternative solvent/binder formulation is required to successfully produce a Li-ion electrode containing the stabilised lithium metal powder. US Patent Application 2004/0002005 (Gao et al) discloses a method of preparing such an anode, and compatible polymer binder and solvent systems. However, whilst the polymer binder and solvent systems may be unreactive with electrode mixes containing the stabilised lithium metal powder, they do not necessarily produce electrodes with good performance.

Accordingly, the present invention provides an anode for a lithium ion cell comprising stabilised lithium metal powder, polyethylene oxide and a lithium intercalation material capable of absorbing and desorbing lithium in an electrochemical system. The lithium present in the anode can intercalate in, alloy with or be absorbed by the lithium intercalation material.

The present invention also provides a process for forming an anode for a lithium ion cell, which process comprises
i) forming a slurry of polyethylene oxide, lithium intercalation material and stabilised lithium metal powder in a solvent;
ii) stirring the slurry to dissolve the polyethylene oxide;
iii) coating the slurry onto a current collector;
iv) drying the slurry to remove the solvent.

The lithium intercalation material is a material capable of absorbing and desorbing lithium in an electrochemical system and may be any material into which lithium intercalates, alloys with, or can be absorbed such as carbon, silicon, tin, tin oxides, composite tin alloys, transition metal oxides or lithium metal oxides. It is preferably carbon, and more preferably graphite.

The stabilised lithium metal powder is any lithium powder which has been treated so as to have some stability compared to untreated lithium powder, such as that produced by FMC Corporation which has a stabilising outer layer. Stabilised lithium powder has typically been treated so as to have a low pyrophoricity compared to untreated lithium powder. Typically, stabilised lithium powder is atmospherically stable. Typically the stabilised lithium powder does not react with air during normal handling procedures but eventually reacts with moisture in the air over time.

The polyethylene oxide may have a range of molecular weights. High molecular weight polyethylene oxide may be preferred as it can produce a suitable anode using less polymer.

The solvent is any solvent in which polyethylene oxide dissolves that is compatible with the stabilised lithium powder, such as benzene, toluene or xylene. Xylene is a preferred solvent. A mixture of solvents may be used.

Typically the slurry is heated so as to dissolve the polyethylene oxide as it is not sufficiently soluble in the selected solvents at room temperature. The slurry may be heated to any temperature below the boiling point of the solvent, such as 40 to 70° C., preferably 50 to 60° C., for example 55° C. For example, polyethylene oxide dissolves in xylene when heated to about 55 to 60° C.

In one embodiment of the present invention the polyethylene oxide is dissolved in the solvent first, optionally with heating, before the lithium intercalation material and stabilised lithium metal powder are added to the solution. The lithium intercalation material and the stabilised lithium metal powder may be added as powders, either together or separately or one or both may be dispersed in a solvent and then added to the polyethylene oxide solution to form a slurry.

In another embodiment, the polyethylene oxide, the stabilised lithium powder and the lithium intercalation material are all added to a solvent to form a slurry. The slurry is then heated if necessary to dissolve the polyethylene oxide.

The current collector is any conductor, typically copper. The copper may be coated with a layer of an electronically conducting material such as carbon to aid adhesion.

The anodes of the present invention may be formed into lithium ion cells with a cathode and a separator. The present invention therefore also provides a lithium ion cell comprising an anode of the present invention and use of an anode of the present invention in a lithium ion cell.

The amount of lithium powder added to the anode can be varied. For example, the entire lithium requirement of the cell may be added to the anode for use with a non-lithiated cathode. Alternatively, an amount of lithium suitable for compensating for the irreversible capacity of the cell may be added to the anode and the anode used with a lithiated cathode. Thus, the present invention has the advantage that the lithium powder can be used to compensate for the irreversible capacity of the cell.

The invention will now be described by way of example and with reference to the drawings filed herewith, in which:

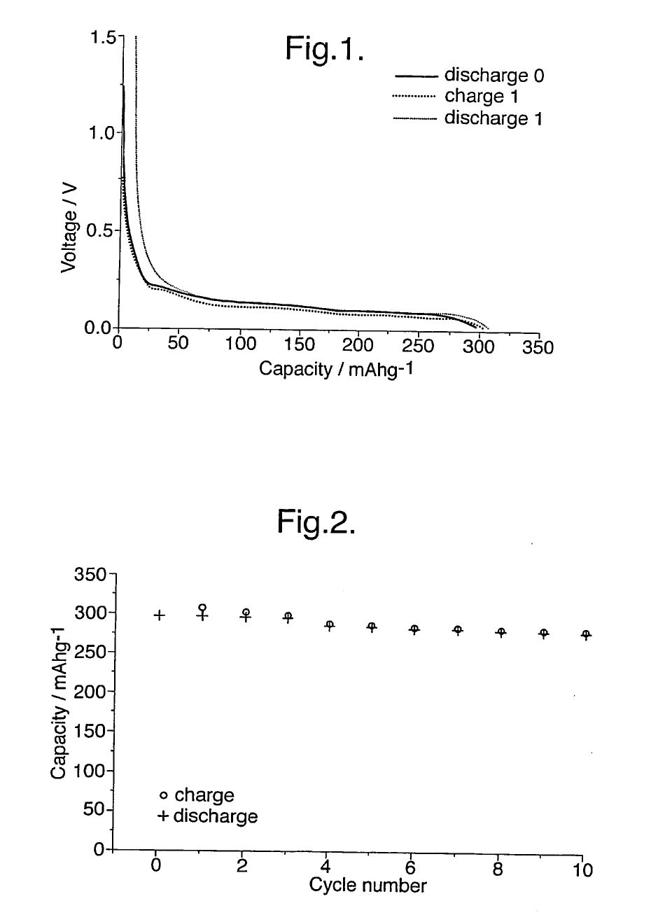

FIG. 1 shows the initial discharge and subsequent first charge and discharge curves for a cell incorporating an anode of Example 1.

FIG. 2 shows the cycle performance of the cell of FIG. 1.

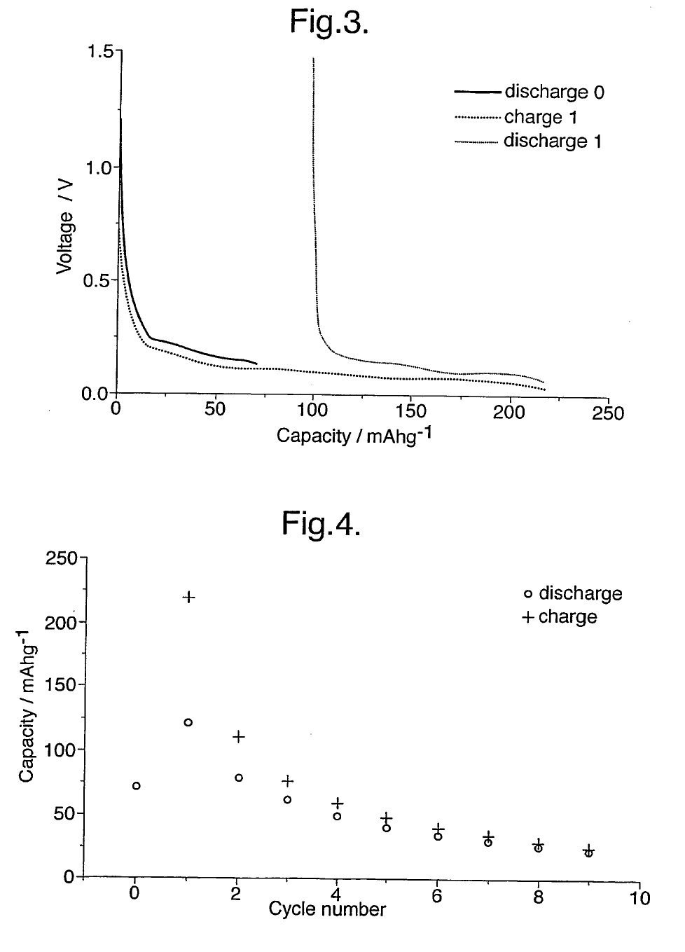

FIG. 3 shows the initial discharge and subsequent first charge and discharge curves for a cell incorporating an anode of Comparative Example 1.

FIG. 4 shows the cycle performance of the cell of FIG. 3.

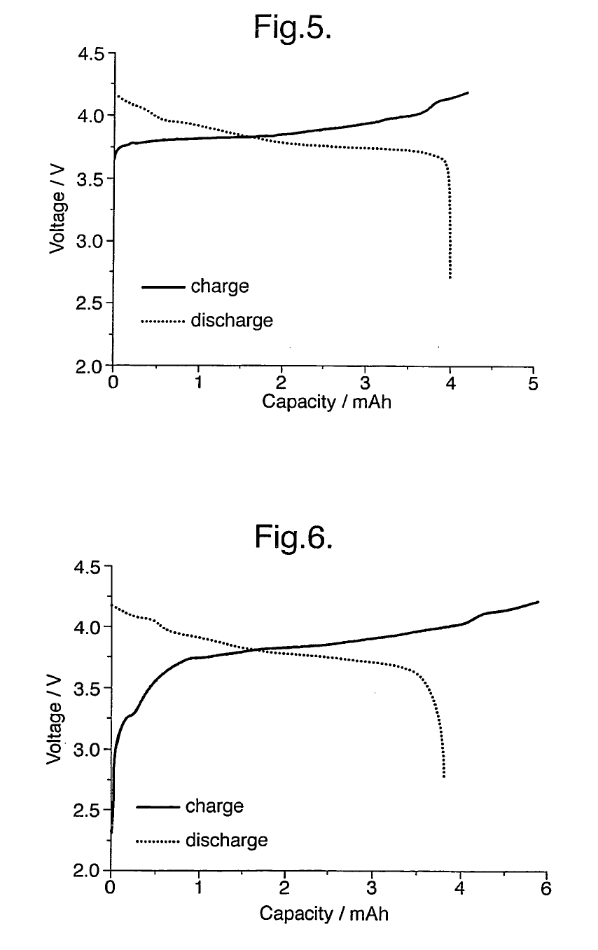

FIG. 5 shows the initial discharge and subsequent first charge and discharge curves for a cell incorporating an anode of Example 2.

FIG. 6 shows the initial discharge and subsequent first charge and discharge curves for a cell incorporating an anode of Comparative Example 2.

The present invention is now described in greater detail by way of example.

### EXAMPLE 1

1.20 g polyethylene oxide (Dow WSR301) was mixed with 34.92 g mesocarbon microbeads 6-28, 3.88 g SFG6 graphite (from Timcal), 3.92 g stabilised lithium metal powder and 90 g xylene. The slurry was stirred and warmed to 60° C. to dissolve the polyethylene oxide fully. A copper foil current collector was pre-coated with a carbon dag layer. The slurry was then coated onto the pre-coated current collector using a doctor blade method and then passed through a two-phase dryer (with zones at 50 and 55° C.) to remove the xylene.

Three-electrode test cells were fabricated from the resulting composite electrode. The composite electrode was cut to a diameter of 12.46 mm. A lithium counter electrode and a lithium reference electrode were used to make up the cells. A glass fibre separator was used with electrolyte containing LiPF₆ in an ethylene carbonate/ethylmethylcarbonate mixture (2:8) mixture. Cells were tested between 0.005V and 1.500 V (relative to the reference electrode) at 0.2 mA using a Macpile II test rig.

FIG. 1 shows the initial discharge (delithiation) of one cell and subsequent first charge and discharge curves.

FIG. 2 shows the cycle performance of this cell.

### COMPARATIVE EXAMPLE 1

50 g ethylene propylene diene monomer was dissolved in 500 g xylene. 406 g mesocarbon microbeads 6-28 and 45 g SFG6 graphite were added to the polymer solution and the mixture stirred until a uniform slurry was obtained. 100 g of this slurry was taken and 4.34 g stabilized lithium metal powder was added. The resultant mixture was stirred until a uniform mix was obtained. The slurry was coated onto a copper foil current collector using a doctor blade method and passed through a dryer to remove the casting solvent.

Three-electrode test cells were fabricated with the composite electrode. Lithium counter and reference electrodes were used. A glass fibre separator was used with electrolyte containing LiPF₆ in an ethylene carbonate/ethylmethylcarbonate mixture (2:8). Cells were tested between 0.01V and 1.500V at 0.2 mA using a Macpile II test rig.

FIG. 3 shows the initial discharge (delithiation) of a cell and subsequent first charge and discharge curves for a cell containing an electrode as described in Comparative Example 1.

FIG. 4 shows the cycle performance of this cell.

### EXAMPLE 2

A composite anode was made in the manner described in Example 1, but the quantity of stabilised lithium metal powder was reduced so as to only compensate for the irreversible capacity of the carbon. 1.40 g polyethylene oxide (Dow WSR301) was mixed with 34.74 g mesocarbon microbeads 6-28, 3.86 g SFG6 graphite, 0.76 g stabilised lithium metal powder and 105 g xylene. The slurry was stirred and warmed to fully dissolve the polyethylene oxide. A copper foil current collector was pre-coated with a carbon dag layer. The slurry was then coated onto the pre-coated current collector using a doctor blade method and passed through a two-phase dryer (with drying zones at 50 and 55° C.) to remove the xylene.

Three-electrode test cells were fabricated with the composite anode. A LiCoO₂ counter electrode and a lithium reference electrode were used. A glass fibre separator was used with electrolyte containing LiPF₆ in an ethylene carbonate/ethylmethylcarbonate mixture (2:8). Cells were tested between 2.70V and 4.20V (voltage across the cell) at 0.3 mA using a Macpile II test rig.

FIG. 5 shows the first charge and discharge curves for a cell of this type. This cell had a first cycle efficiency of 95.4%.

### COMPARATIVE EXAMPLE 2

A composite anode was made in the manner described in Example 2 but without the addition of stabilised lithium metal powder. Three-electrode test cells were assembled and tested as described in Example 2.

FIG. 6 shows the first charge and discharge curves for a cell of this type. This cell had a first cycle efficiency of 77.9%.

Comparing FIGS. 1 and 2 with FIGS. 3 and 4, it can be seen that the cell of Example 1 shows that practically full lithiation of the carbon electrode has been achieved with an almost negligible irreversible capacity as exemplified by the difference between the discharge labelled 0 and the discharge labelled 1 (the first real discharge). The cell of Example 1 also shows a very good cycle performance in FIG. 2. In contrast the cell of Comparative Example 1 shows a clear irreversible capacity in FIG. 3 and poor cycle performance in FIG. 4 with the cell capacity dropping off considerably in only 9 cycles. This indicates the benefit of using polyethylene oxide as a binder compared to ethylenepropylene diene monomer.

Comparing FIG. 5 with FIG. 6, it can be seen that the cell of Example 2 has a much higher first cycle efficiency (ratio of discharge capacity to charge capacity) than the cell of Comparative Example 2 due to the addition of stabilised lithium powder to the electrode to compensate for the irreversible capacity of the anode.

1. An anode for a lithium ion cell comprising stabilised lithium metal powder, polyethylene oxide and a lithium intercalation material.

2. An anode according to claim 1 wherein the lithium intercalation material is carbon.

3. An anode according to claim 2 wherein the lithium intercalation material is graphite.

4. A process for forming an anode for a lithium ion cell, which process comprises
i) forming a slurry of polyethylene oxide, lithium intercalation material and stabilised lithium metal power in a solvent;
ii) stirring the slurry to dissolve the polyethylene oxide;
iii) coating the slurry onto a current collector;
iv) drying the slurry to remove the solvent.

5. A process according to claim 4 wherein the solvent is xylene.

6. A process according to claim 4 wherein the slurry is heated to dissolve the polyethylene oxide.

7. A cell comprising an anode according to claim 1.

8. Use of an anode according to claim 1 in a cell.
